(19) United States
(12) Patent Application Publication
(10) Pub. No.: US 2005/0063687 A1
(43) Pub. Date: Mar. 24, 2005

(54) Horizontal baffle for water tanks that floats at largest temperature gradient

(76) Inventor: Phillip Charles Watts, Longmont, CO (US)

Correspondence Address: Phillip Charles Watts, 1404 Kay St #1, Longmont, CO, 80501, US

(21) Appl. No.: 10/939,843

(22) Filed: Sep. 13, 2004

Related U.S. Application Data
(60) Provisional application No. 60/503,078, filed on Sep. 15, 2003.

(51) Int. Cl. H05B 3/00

(52) U.S. Cl. 392/441; 219/201

(57) ABSTRACT

This invention embodies an variable specific gravity horizontal baffle that can follow the border of a temperature gradient of a working fluid of higher and lower temperatures by generating it's own control power from the differential temperatures with thermoelectric modules driving shape memory alloy Nitenol Wires to open and close water shutters designed to reduce water resistance to the baffle's changing positions.

### CROSS-REFERENCE TO RELATED APPLICATIONS

Provisional Patent 60/503,078 filed Sep. 15, 2003.

### STATEMENT REGARDING FEDERALLY SPONORED RESEARCH OR DEVELOPMENT

Not applicable

### REFERENCE TO A MICROFICHE APPENDIX

Not applicable

### BACKGROUND OF THE INVENTION

Convection currents can be minimized through the use of a horizontal baffle that can separate a tanks contents based on temperature differences.

### BRIEF SUMMARY OF THE INVENTION

A non-tethered or tethered apparatus enabling hot water storage tanks to prevent convection cooling by a buoyant barrier that separates the warmer stratified water from the cooler stratified water by sensing water temperature by a Thermo-Electric Module. The Thermo-Electric Module provides the energy to break water into hydrogen and oxygen. The amount of hydrogen and oxygen gas controls the floating of the baffle to separate the temperature gradients of warmer and cooler water.

### BRIEF DESCRIPTION OF THE SEVERAL VIEWS OF THE DRAWING

FIG. 1. Thermoelectric Floating Horizontal Baffle in Tank FIG. 1. depicts a thermoelectric generator and floating baffle with a high voltage discharge circuit.

### DETAILED DESCRIPTION OF THE INVENTION

This application pertains to tethered or non-tethered horizontal baffle apparatus used in water storage in any tank geometry. The baffle minimizes convection by being able to transverse the entire tank height so as to follow the temperature gradient of the tank seperating the warmer from the cooler water in storage or during dynamic changing of water temperature at top or bottom of the tank.

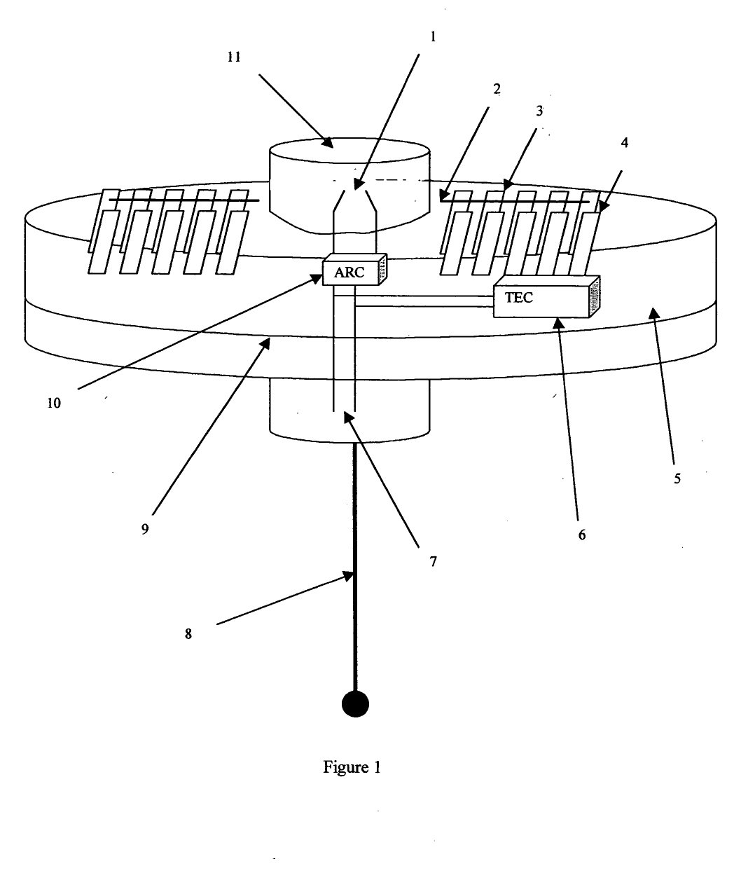

Refer to FIG. 1 for the following description. Consider a tank of water with hot water entering at the top of the tank and cold water entering at the bottom of the tank. The floating baffle body, number 5, just smaller than the tank diameter. The tank of water can be cycled more than once during a charging with hot water and in this case the horizontal baffle has to be able to float and sink on command. A Thermoelectric, number 6, has hot water floating over the top of the baffle, number 5. The same thermoelectric has cold water flowing below it, number 9 of the horizontal baffle. Number 8 provides stability for the baffle to remain parallel while moving in the tank. When the floating baffle is moving either up or down water resistance is reduced by opening up shutters, numbers 3 and 4. These shutters are moved by a Nitenol Metal lever that changes length when an electrical current passes through it. When the movement of the baffle is completed the current through the Nitenol Metal lever, number 2 is reduced as the ThermoElectric Module, number 6, produces less energy when the gradient is less.

To sink the horizontal baffle, number 10, a high voltage arc system produces 3,000 volts to probes, number 1. The Arc inside number 11, at probes, number 1, recombines the hydrogen and oxygen gas into water and the baffle sinks. As the Thermoelectric generates electricity the water at probes, number 7, is separated into hydrogen and oxygen and gives the baffle buoyancy. Colder water entering the bottom of the tank, in reference to higher temperature water that enters at the top of the tank Colder water is diverted through a small tube to flow beneath the Nitenol Metal lever, number 2, while the remaining major flow of incoming colder water is trained in a constrained non-mixing flow at the bottom of the tank.

1. A nontethered horizontal baffle that has its own internal power source, such as thermoelectric for tracking a temperature gradient in a storage tank utilizing Shape Memory Alloys as Nitenol Metal wire for control levers;

2. A tethered horizontal baffle that has external power source and compressed air to float or sink a baffle or to track a gradient with external processing;

3. A horizontal baffle that can be cycled from the top to bottom of a tank multiple times as the contents of the tank are cycled multiple times and minimize convection currents that would cool off the tank contents.

4. Power for operating baffles to minimize water resistance can be driven from compressed air, Shape Memory Alloys, hydrogen and oxygen cylinders or external tethered wires or gas delivery tubes to raise or lower the baffle.
